(19) United States
(12) Patent Application Publication
(10) Pub. No.: US 2019/0322242 A1
(43) Pub. Date: Oct. 24, 2019

(54) AUTHENTICATION SYSTEM, PORTABLE DEVICE, AUTHENTICATION DEVICE AND REGISTRATION METHOD

(71) Applicant: ALPS ALPINE CO., LTD., Tokyo (JP)

(72) Inventor: Kiyoshi KOIKE, Miyagi (JP)

(21) Appl. No.: 16/502,160

(22) Filed: Jul. 3, 2019

Related U.S. Application Data
(63) Continuation of application No. PCT/JP2017/030539, filed on Aug. 25, 2017.

(30) Foreign Application Priority Data
Feb. 8, 2017 (JP) 2017-021695

(51) Int. Cl. B60R 25/24; H04W 12/06; B60R 25/20; E05B 81/00

(52) U.S. Cl. CPC B60R 25/24; H04W 12/06; E05Y 2900/531; E05B 81/00; E05Y 2400/852; B60R 25/209

(57) ABSTRACT

An authentication system includes at least one portable device and an authentication device. The at least one portable device includes a measurement unit configured to measure a signal intensity value in communicating with an authentication device, prior to registering of an authentication ID of the portable device by the authentication device, and an ID transmitting unit configured to transmit, to the authentication device, the authentication ID at a transmission timing depending on the signal intensity value measured by the measurement unit. The authentication device includes a receiving unit configured to receive the authentication ID transmitted by the portable device, a determination unit configured to select, as a target authentication ID, the authentication ID transmitted at a predetermined timing by the portable device, among at least one authentication ID received by the receiving unit, and a registration unit configured to register the target authentication ID selected by the determination unit.

### CROSS-REFERENCE TO RELATED APPLICATION

This application is a continuation application of International Application No. PCT/JP2017/030539 filed on Aug. 25, 2017, and designated the U.S., which is based upon and claims priority to Japanese Patent Application No. 2017-021695, filed on Feb. 8, 2017, the entire contents of which are incorporated herein by reference.

### BACKGROUND OF THE INVENTION

### 1. Field of the Invention

The present disclosure relates to an authentication system, a portable device, an authentication device and a registration method.

### 2. Description of the Related Art

For electronic key systems known in the art, authentication IDs have been transmitted by respective electronic keys, each of which is carried by a user, to a given in-vehicle device in order to authenticate using the authentication IDs. Thus, each of the electronic key systems can lock or release a door lock of a vehicle by remote control through an electronic key. For instance, in such an electronic key system, in a case where an electronic key is lost or damaged or where an electronic key is newly provided or the like, a new electronic key can be registered by an in-vehicle device.

For instance, in order to register an electronic key with an in-vehicle device, Japanese Unexamined Patent Application Publication No. 2013-079554 (Patent Document 1) discloses techniques of changing a reception frequency of the in-vehicle device such that the reception frequency corresponds to a transmission frequency of the electronic key, when the transmission frequency of the electronic key, which is included in information transmitted by the electronic key to the in-vehicle device, does not correspond to the reception frequency of the in-vehicle device, which is set in a memory in the in-vehicle device. Information relating to the electronic key then is registered in the memory of the in-vehicle device. According to such techniques, in a case of registering an electronic key by an in-vehicle device, even when a reception frequency of an in-vehicle device does not correspond to a transmission frequency of an electronic key, costs of registration for the electronic key are known to be saved by changing the reception frequency of the in-vehicle device, because the in-vehicle device is not needed to be replaced by a new one.

### SUMMARY OF THE INVENTION

In one aspect according to embodiments, an authentication system includes at least one portable device including: a measurement unit configured to measure a signal intensity value in communicating with an authentication device, prior to registering of an authentication ID of the portable device by the authentication device; and an ID transmitting unit configured to transmit, to the authentication device, the authentication ID at a transmission timing depending on the signal intensity value measured by the measurement unit; and the authentication device including: a receiving unit configured to receive the authentication ID transmitted by the portable device; a determination unit configured to select, as a target authentication ID, the authentication ID transmitted at a predetermined timing by the portable device, among at least one authentication ID received by the receiving unit; and a registration unit configured to register the target authentication ID selected by the determination unit.

### BRIEF DESCRIPTION OF THE DRAWINGS

Other objects and further features of embodiments will become apparent from the following detailed description when read in conjunction with the accompanying drawings, in which:

FIG. 1 is a diagram illustrating an example of a device configuration of an electronic key system according to one embodiment;

FIG. 2 is a diagram illustrating an example of a functional configuration of an in-vehicle device and an electronic key according to one embodiment;

FIG. 3 is a diagram illustrating a specific example of a determination table stored in a storage unit according to one embodiment;

FIG. 4 is a flowchart illustrating an example of processing performed by the electronic key according to one embodiment;

FIG. 5 is a flowchart illustrating an example of processing performed by the in-vehicle device according to one embodiment;

FIG. 6 is a diagram illustrating a case where a plurality of electronic keys for use in an electronic key system are located by way of example; and

FIG. 7 is a diagram illustrating an example of timing of various operations in the electronic key system according to one embodiment.

### DESCRIPTION OF THE PREFERRED EMBODIMENTS

The inventor has recognized that, typically, as a method of registering an electronic key with an in-vehicle device, the following is employed: the in-vehicle device transmits a request signal for requesting to transmit an authentication ID. When receiving the request signal, an electronic key transmits an authentication ID of the electronic key to the in-vehicle device. The in-vehicle device then registers this authentication ID. However, according to the recognition by the inventor, when there are multiple electronic keys in the surroundings of the in-vehicle device, the multiple electronic keys may simultaneously transmit respective authentication IDs. In this case, the in-vehicle device may register a wrong authentication ID, or may be unable to successfully register a target authentication ID on account of interference of transmission waves used for the multiple authentication IDs.

In view of the above, by way of example, the inventor has recognized the following: in registering an authentication ID of a portable device with an authentication device, an authentication ID of an authorized portable device is required to be successfully registered, even when authentication IDs from respective portable devices existing in the surroundings of the authentication device are transmitted.

Embodiments will be explained hereinafter with reference to the drawings.

### Device Configuration of Electronic Key System 10

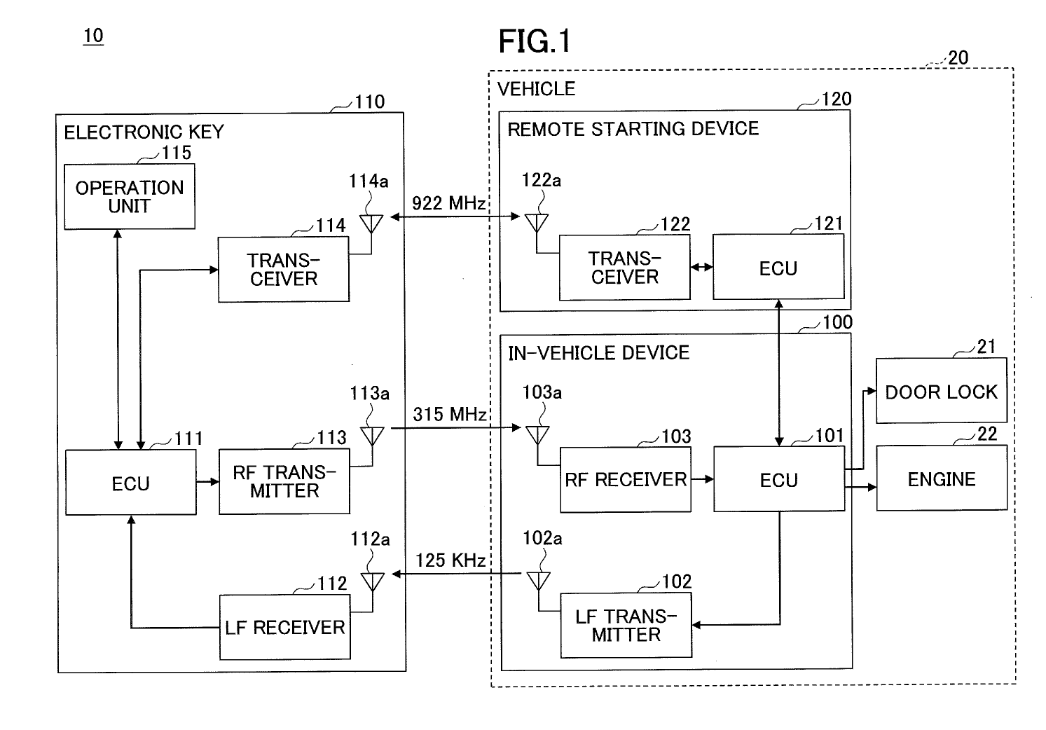

FIG. 1 is a diagram illustrating an example of a device configuration of an electronic key system 10 according to one embodiment. The electronic key system 10 illustrated in FIG. 1 is an example of an “authentication system”. As illustrated in FIG. 1, the electronic key system 10 includes an electronic key 110, an in-vehicle device 100, and a remote starting device 120.

The in-vehicle device 100 is an example of an “authentication device”, and is provided with the vehicle 20. The in-vehicle device 100 is a device that controls remote operation of a door lock 21 and an engine 22 of the vehicle 20 through the electronic key 110 as well as authentication for the electronic key 110.

As illustrated in FIG. 1, the in-vehicle device 100 includes an ECU (Electronic Control Unit) 101, an LF (Low Frequency) transmitter 102, and a RF (Radio Frequency) receiver 103.

The ECU 101 controls the whole in-vehicle device 100, and performs various processing (e.g., processing of transmitting and receiving various data signals for use in the electronic key 110, processing of perfoLming authentication for the electronic key 110, and processing of controlling the door lock 21 and the engine 22 in accordance with remote operation through the electronic key 110, or the like).

The LF transmitter 102 transmits various data signals to the electronic key 110 existing in the surroundings of the in-vehicle device 100 through LF band communication via an LF antenna 102a. The LF band communication refers to wireless communication of which the frequency band ranges from 30 KHz to 300 KHz. In the present embodiment, a frequency used in LF band communication is 125 KHz that is capable of communicating at a relatively short distance (e.g., 2 meters).

The RF receiver 103 receives various data signals transmitted by the electronic key 110 through UHF band communication via a RF antenna 103a. The UHF band communication refers to wireless communication of which the frequency band ranges from 300 MHz to 3 GHz. In the present embodiment, a frequency used in UHF band communication is 315 MHz that is capable of communicating at a relatively short distance (e.g., 20 meters).

The electronic key 110 is an example of a “portable device” and is carried by a user. The electronic key 110 is a device for remotely operating the door lock 21 and the engine 22 of the vehicle 20.

As illustrated in FIG. 1, the electronic key 110 includes an ECU 111, an LF receiver 112, an RF transmitter 113, a transceiver 114, and an operation unit 115.

The ECU 111 controls the whole electronic key 110, and performs various processing of the electronic key 110 (e.g., processing of transmitting and receiving various data signals for use in the in-vehicle device 100 and the remote starting device 120, or the like).

The LF receiver 112 receives various data signals (e.g., request signals used by an authentication function) transmitted by the in-vehicle device 100 through LF band communication (125 KHz) via an LF antenna 112a.

The RF transmitter 113 transmits various data signals (e.g., response signals used by the authentication function) to the in-vehicle device 100 through UHF band communication (315 MHz) via an RF antenna 113a.

The transceiver 114 transmits and receives various data signals for use in the remote starting device 120 through wireless communication via a transceiver antenna 114a. In the present embodiment, communication between the electronic key 110 and the remote starting device 120 is bidirectional, and such a bidirectional communication is performed on a same frequency. In the present embodiment, a frequency used in communication between the electronic key 110 and the remote starting device 120 is 922 MHz that is capable of communicating at a relatively long distance (e.g., 200 meters).

The operation unit 115 is an input device used when various operations (e.g., remote operation of the door lock 21, remote operation of the engine 22, and the like) are performed by a user. For example, the operation unit 115 includes a push button, a touch panel, a display, and the like.

The remote starting device 120 is an example of an “intermediate device”, and is coupled to the in-vehicle device 100 via a communication cable or the like. The remote starting device 120 is a device that controls remote operation of the engine 22 of the vehicle 20 through the electronic key 110.

As illustrated in FIG. 1, the remote starting device 120 includes an ECU 121 and a transceiver 122.

The ECU 121 controls the entire remote starting device 120, and performs various processing of the remote starting device 120 (e.g., processing of transmitting and receiving various data signals for use in the electronic key 110 and processing of forwarding various data signals for use in the in-vehicle device 100, or the like).

The transceiver 122 transmits and receives various data signals for use in the electronic key 110 through wireless communication (922 MHz) via a transceiver antenna 122a.

Such an electronic key system 10 can perform remote control of door lock 21 through the electronic key 110, through LF band communication (125 KHz) and UHF band communication (315 MHz). For example, in a case of remotely operating the door lock 21, the in-vehicle device 100 transmits a request signal to surroundings of the in-vehicle device 100 through LF band communication (125 KHz). When the electronic key 110 existing in the surroundings of the in-vehicle device 100 (in a communication area where the request signal reaches) receives such a request signal, the electronic key 110 transmits a response signal, which includes an authentication ID of the electronic key 110, to the in-vehicle device 100 through UHF band communication (315 MHz). Upon receipt of this response signal, the in-vehicle device 100 performs authentication for the electronic key 110 with the authentication ID included in the response signal. When authentication for the electronic key 110 is achieved by the in-vehicle device 100, remote control (locking or unlocking) of the door lock 21 can be performed by the electronic key 110.

Also, in the electronic key system 10, remote control of the engine 22 can be performed by the electronic key 110 through communication (922 MHz) with the remote starting device 120. For example, in a case of operating the engine 22 remotely, first, when the user operates the electronic key 110 in a predetermined manner (e.g., a start button or a stop button is pressed), the electronic key 110 transmits a remote-operation-request signal, which includes an authentication ID of the electronic key 110, to the in-vehicle device 100 through communication (922 MHz) with the remote starting device 120. The in-vehicle device 100 receives this remote-operation-request signal and then achieves authentication for the electronic key 110 using the authentication ID included in the remote-operation-request signal. The electronic key 110 is authenticated, and thus the in-vehicle device 100 causes the engine 22 to start or stop in accordance with the remote-operation-request signal. Upon the engine 22 starting or stopping, the in-vehicle device 100 transmits, to the electronic key 110, information for indicating that the engine 22 has started or stopped, via the remote starting device 120. When receiving such information, the electronic key 110 indicates to the user information indicating that the engine 22 has started or stopped, by displaying such information on a display provided with the operation unit 115, etc.

In addition, in the electronic key system 10, by way of example, an authentication ID of a new electronic key 110 can be registered by the in-vehicle device 100 through communication (922 MHz) with the remote starting device 120 in the following case: a case where an electronic key 110 is initially registered, a case where an electronic key 110 is lost or damaged, a case where a new electronic key 110 is added, etc. As an example, in the electronic key system 10, in a case of registering an authentication ID of a new electronic key 110, an authentication ID of another electronic key 110 can be prevented from being registered faultily, or alternatively, interference of transmission waves with use for respective authentication IDs can be avoided. This point is described in detail below.

### Functional Configuration of Electronic Key System 10

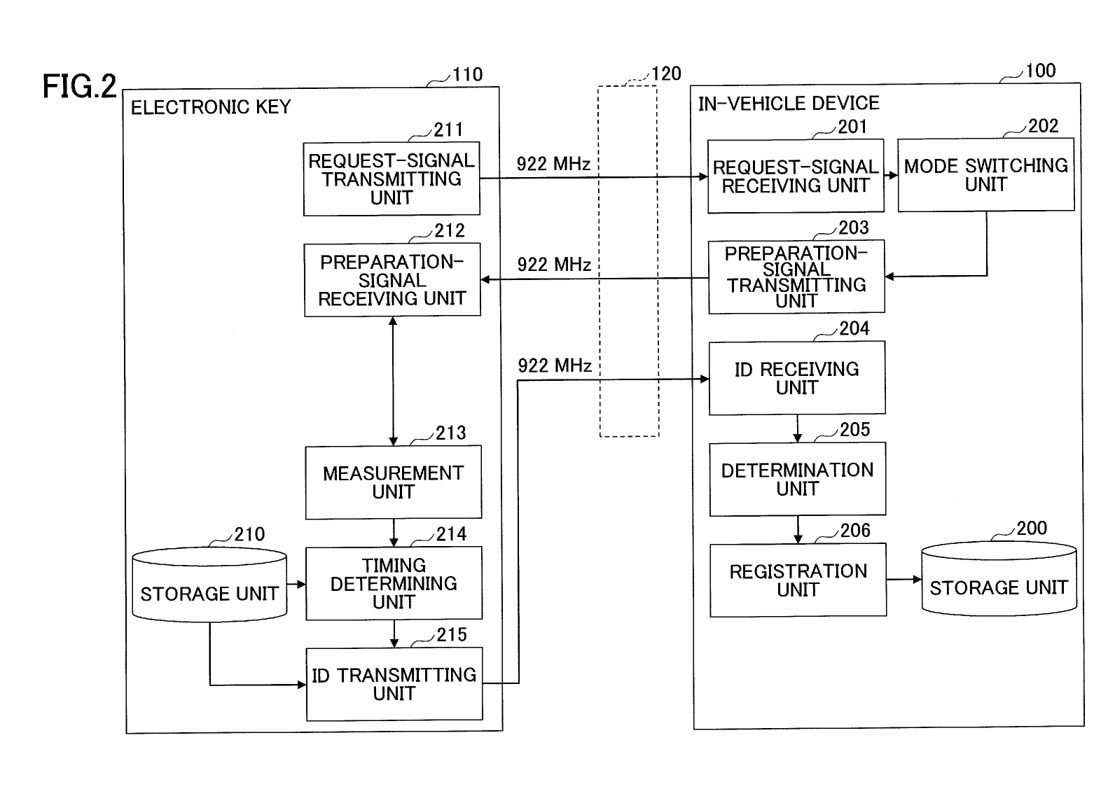

FIG. 2 is a diagram illustrating an example of a functional configuration of the in-vehicle device 100 and the electronic key 110 according to one embodiment.

As illustrated in FIG. 2, the in-vehicle device 100 includes a storage unit 200, a request-signal receiving unit 201, a mode switching unit 202, a preparation-signal transmitting unit 203, an ID receiving unit 204, a determination unit 205, and a registration unit 206.

The request-signal receiving unit 201 receives an ID-registration-request signal transmitted by the electronic key 110 via the remote starting device 120. Specifically, an ID-registration-request signal transmitted by the electronic key 110 is received by the remote starting device 120, and then is forwarded to the in-vehicle device 100 by the remote starting device 120. Accordingly, the request-signal receiving unit 201 receives, from the remote starting device 120, the ID-registration-request signal transmitted by the electronic key 110. Note that the ID-registration-request signal refers to a signal for requesting the in-vehicle device 100 to register an authentication ID.

When the request-signal receiving unit 201 receives the ID-registration-request signal, the mode switching unit 202 switches the operation of the in-vehicle device 100, from a “normal mode” for authentication for the electronic key 110 as well as for remote operation through the electronic key 110 to a “registration mode” for registering ID-registration information.

When the operation of the in-vehicle device 100 is switched to the “registration mode” by the mode switching unit 202, the preparation-signal transmitting unit 203 transmits an ID-registration-preparation signal to the electronic key 110 existing in the surroundings of the in-vehicle device 100 via the remote starting device 120. Specifically, the preparation-signal transmitting unit 203 transmits an ID-registration-preparation signal to the remote starting device 120. In response to this transmission, the remote starting device 120 transmits the ID-registration-preparation signal to the electronic key 110 existing in the surroundings of the in-vehicle device 100. Note that the ID-registration-preparation signal refers to a signal for requesting the electronic key 110 to transmit ID-registration information.

The ID receiving unit 204 receives ID-registration information transmitted by the electronic key 110 via the remote starting device 120. Specifically, ID-registration information transmitted by the electronic key 110 is received by the remote starting device 120, and then is forwarded to the in-vehicle device 100 by the remote starting device 120. Accordingly, the request-signal receiving unit 201 receives the ID-registration information transmitted by the electronic key 110, via the remote starting device 120. Note that the ID-registration information includes an authentication ID of at least one electronic key 110.

The determination unit 205 selects, as target ID-registration information, ID-registration information transmitted at a predetermined timing, among ID registration information received by the ID receiving unit 204. As an example, in the present embodiment, the determination unit 205 selects, as target ID-registration information, ID-registration information transmitted at an earliest timing, among ID registration information received by the ID receiving unit 204.

The registration unit 206 registers the target ID-registration information (e.g., the ID-registration information transmitted at the earliest timing) selected by the deteLmination unit 205, in the storage unit 200. The storage unit 200 stores the ID-registration information registered by the registration unit 206. When the ID-registration information is stored in the storage unit 200, the in-vehicle device 100 can perform authentication for the electronic key 110 corresponding to such ID-registration information.

The electronic key 110, on the other hand, includes a storage unit 210, a request-signal transmitting unit 211, a preparation-signal receiving unit 212, a measurement unit 213, a timing determining unit 214, and an ID transmitting unit 215.

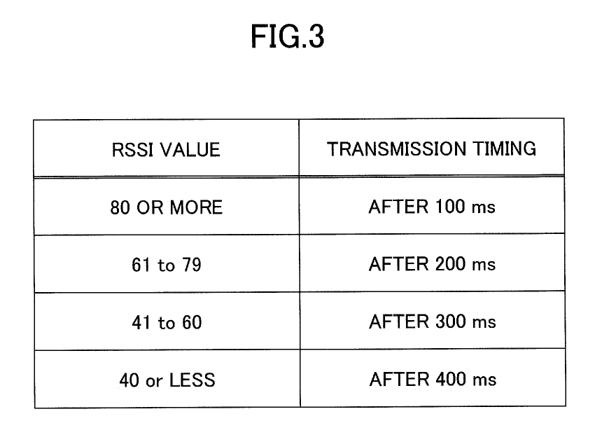

The storage unit 210 stores ID-registration information that includes an authentication ID of a given electronic key 110. Also, the storage unit 210 stores a determination table for determining a transmission timing of ID-registration information. In the determination table, the transmission timing is preliminarily set for each range of RSSI (Received Signal Strength Indicator) values. As an example, in the determination table, the transmission timing is set so as to become early as a RSSI value increases. Note that a specific example of the determination table stored in the storage unit 210 will be described below with reference to FIG. 3.

When a predetermined operation (e.g., a plurality of push buttons are pressed simultaneously, etc.) is performed using the electronic key 110 by the user, the request-signal transmitting unit 211 transmits an ID-registration-request signal to the in-vehicle device 100 through communication (922 MHz) with the remote starting device 120. Specifically, the request-signal transmitting unit 211 transmits an ID-registration-request signal to the remote starting device 120 through communication (922 MHz) with the remote starting device 120. When receiving this ID-registration-request signal, the remote starting device 120 forwards the ID-registration-request signal to the in-vehicle device 100.

The preparation-signal receiving unit 212 receives an ID-registration-preparation signal transmitted by the in-vehicle device 100 through communication (922 MHz) with the remote starting device 120. Specifically, an ID-registration-preparation signal is transmitted from the in-vehicle device 100 to the remote starting device 120, and then is forwarded to the electronic key 110 by the remote starting device 120. Accordingly, the electronic key 110 receives the ID-registration-preparation signal from the remote starting device 120.

The measurement unit 213 measures a RSSI value (which is an example of a signal intensity value) in performing communication (922 MHz) with the remote starting device 120, when the preparation-signal receiving unit 212 receives the ID-registration-preparation signal. Note that as a manner of measuring a RSSI value, various methods known in the art can be used.

The timing determining unit 214 determines a transmission timing of ID-registration information based on a RSSI value measured by the measurement unit 213. Specifically, with reference to the determination table stored in the storage unit 210, the timing determining unit 214 determines, as the transmission timing of ID-registration information, a transmission timing corresponding to the RSSI value measured by the measuring unit 213.

The ID transmitting unit 215 transmits, to the in-vehicle device 100, ID-registration information stored in the storage unit 210 at the transmission timing determined by the timing determining unit 214, through communication (922 MHz) with the remote starting device 120. Specifically, the ID transmitting unit 215 transmits ID-registration information to the remote starting device 120 through communication (922 MHz) with the remote starting device 120. When receiving the ID-registration information, the remote starting device 120 forwards the ID-registration information to the in-vehicle device 100.

Note that each functional unit of the in-vehicle device 100 is implemented by a processor executing a program that is stored in a memory in the ECU 101 (computer) provided with the in-vehicle device 100, by way of example. In addition, each functional unit of the electronic key 110 is implemented by a processor executing a program that is stored in a memory in the ECU 111 (computer) provided with the electronic key 110, by way of example. As an example of the processor, a CPU (Central Processing Unit), an MPU (Micro processing unit), or the like is used. As an example of the memory, a ROM (Read Only Memory), a RAM (Random Access Memory), or the like is used.

Such a program may be provided along with the in-vehicle device 100 or the electronic key 110 in which the program is preliminarily installed. Alternatively, such a program is provided alone in such a manner that is separated from the in-vehicle device 100 or the electronic key 110, and then may be installed in the in-vehicle device 100 or the electronic key 110. In this case, such a program may be provided using an external storage media (e.g., a USB memory, a memory card, a CD-ROM, etc.), or may be provided by downloading it from a server over a network (e.g., the Internet, etc.).

### Specific Example of Determination Table

FIG. 3 is a diagram illustrating a specific example of a determination table stored in the storage unit 200 according to one embodiment.

As illustrated in FIG. 3, in the determination table, a transmission timing (a delay time until ID-registration information is transmitted) is set for each range of RSSI values. The determination table is referenced in determining the transmission timing of ID-registration information by the timing determining unit 214. In an example of the determination table in FIG. 3, the transmission timing is set so as to become early as a RSSI value increases.

For example, in the determination table of FIG. 3, “after 100 ms” is set for RSSI values “80 or more”, “after 200 ms” is set for RSSI values “61 to 79”. Further, “after 300 ms” is set for RSSI values “41 to 60”, and “after 400 ms” is set for RSSI values “40 or less”. In such a manner, as an example, ID-registration information of the electronic key 110 existing closest to the in-vehicle device 100 is transmitted at an earliest timing, and then is registered in the in-vehicle device 100.

Note that, in the determination table illustrated in FIG. 3, a range of RSSI values is classified into four levels, but is not limited thereto. For example, with respect to the determination table, the range of RSSI values may be classified into three levels or less, or be classified into 5 levels or more. Further, instead of referencing the determination table, the timing determining unit 214 may calculate a transmission timing (a delay time until ID-registration information is transmitted) with use of a given RSSI value, based on a predetermined arithmetic equation.

### Processing of Electronic Key 110

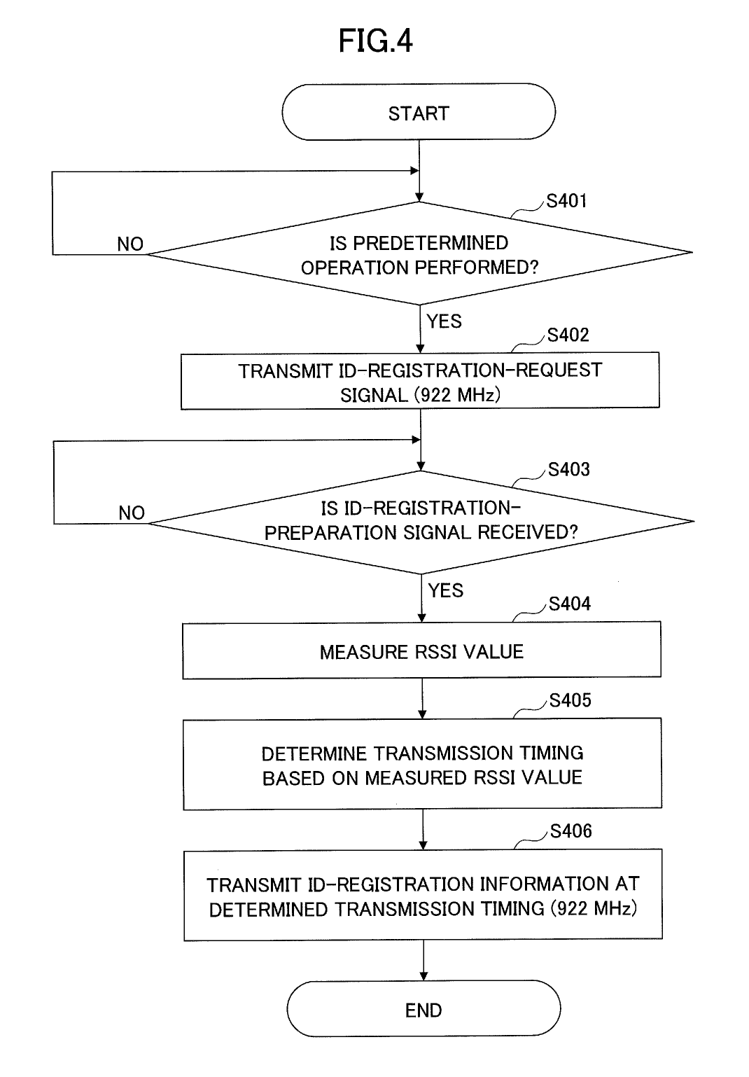

FIG. 4 is a flowchart illustrating processing performed by the electronic key 110 according to one embodiment.

First, the request-signal receiving unit 201 determines whether or not a predetermined operation is performed using the operation unit 115 by a user (step S401). In step S401, when it is deteLmined that a predetermined operation is not performed (step S401: NO), the request-signal receiving unit 201 again executes a determination process in step S401.

On the other hand, in step S401, when it is determined that a predetermined operation is performed (step S401: YES), the request-signal receiving unit 201 transmits an ID-registration-request signal to the in-vehicle device 100 through communication (922 MHz) with the remote starting device 120 (step S402).

Next, the preparation-signal receiving unit 212 determines whether or not an ID-registration-preparation signal transmitted by the in-vehicle device 100 is received through communication (922 MHz) with the remote starting device 120 (step S403). In step S403, when it is determined that the ID-registration-preparation signal is not received (step S403: NO), the preparation-signal receiving unit 212 again executes a determination process in step S403.

On the other hand, in step S403, when it is determined that the ID-registration-preparation signal is received (step S403: YES), the measurement unit 213 measures a RSSI value in communication (922 MHz) with the remote starting device 120, when the ID-registration-preparation signal is received (step S404).

The timing determining unit 214 determines a transmission timing of ID-registration information based on the RSSI value measured in step S404 (step S405). Further, the ID transmitting unit 215 transmits ID-registration infoLmation to the in-vehicle device 100 at the transmission timing determined in step S405 (step S406). The electronic key 110 then finishes the step sequence illustrated in FIG. 4.

### Processing of In-Vehicle Device 100

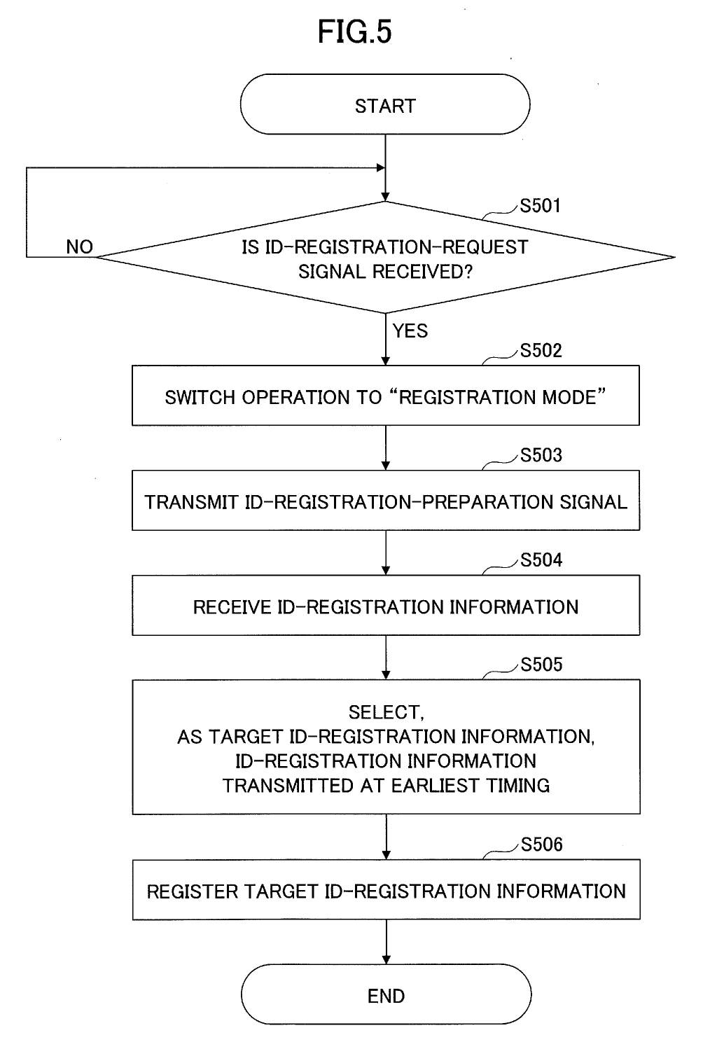

FIG. 5 is a flowchart illustrating processing performed by the in-vehicle device 100 according to one embodiment.

First, the request-signal receiving unit 201 determines whether or not an ID-registration-request signal transmitted by the electronic key 110 is received via the remote starting device 120 (step S501). In step S501, when it is deteLmined that an ID-registration-request signal is not received (step S501: NO), the request-signal receiving unit 201 again executes a determination process in step S501.

On the other hand, in step S501, when it is determined that an ID-registration-request signal is received (step S501: YES), the mode switching unit 202 switches the operation of the in-vehicle device 100 from the “normal mode” to the “registration mode” (step S502). The preparation-signal transmitting unit 203 then transmits an ID-registration-preparation signal to the electronic key 110 existing in the surroundings of the in-vehicle device 100, via the remote starting device 120 (step S503).

Next, the ID receiving unit 204 receives an ID-registration-preparation signal from the electronic key 110 that has received the ID-registration-preparation signal, via the remote starting device 120 (step S504). In such a manner, if there are a plurality of electronic keys 110 in the surroundings of the in-vehicle device 100, the ID receiving unit 204 receives ID-registration information from each electronic key 110.

The determination unit 205 determines, as a target ID-registration information, ID-registration information transmitted at an earliest timing, among ID-registration information received in step S504 (step S505). Further, the registration unit 206 registers the target ID-registration information determined in step S505 in the registration unit 206 (step S506). The in-vehicle device 100 then finishes a step sequence as illustrated in FIG. 5.

### Example of Locations of a Plurality of Electronic Keys 110

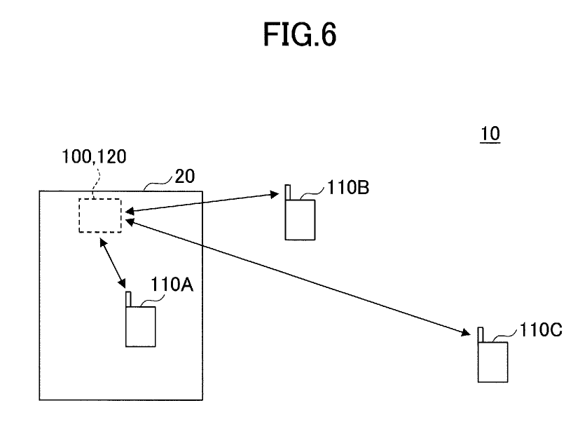

As an example, FIG. 6 is a diagram illustrating a case where a plurality of electronic keys 110 in the electronic key system 10 are present. In an example in FIG. 6, there are three electronic keys 110A, 110B and 110C in the surroundings of the in-vehicle device 100 and the remote starting device 120. Each of the electronic keys 110A, 110B and 110C has a similar configuration to the electronic key 110 described above. In this example, the electronic key 110A exists at a location (a location inside the vehicle 20 being a predetermined registration location) closest to the in-vehicle device 100 and the remote starting device 120. In such a manner, the electronic key 110A transmits ID-registration information to the in-vehicle device 100 at an earliest timing. Thereby, the in-vehicle device 100 registers the ID-registration information of the electronic key 110A, without registering ID-registration information of each of the remaining electronic keys 110B and 110C.

### Timing of Various Operations in Electronic Key System 10

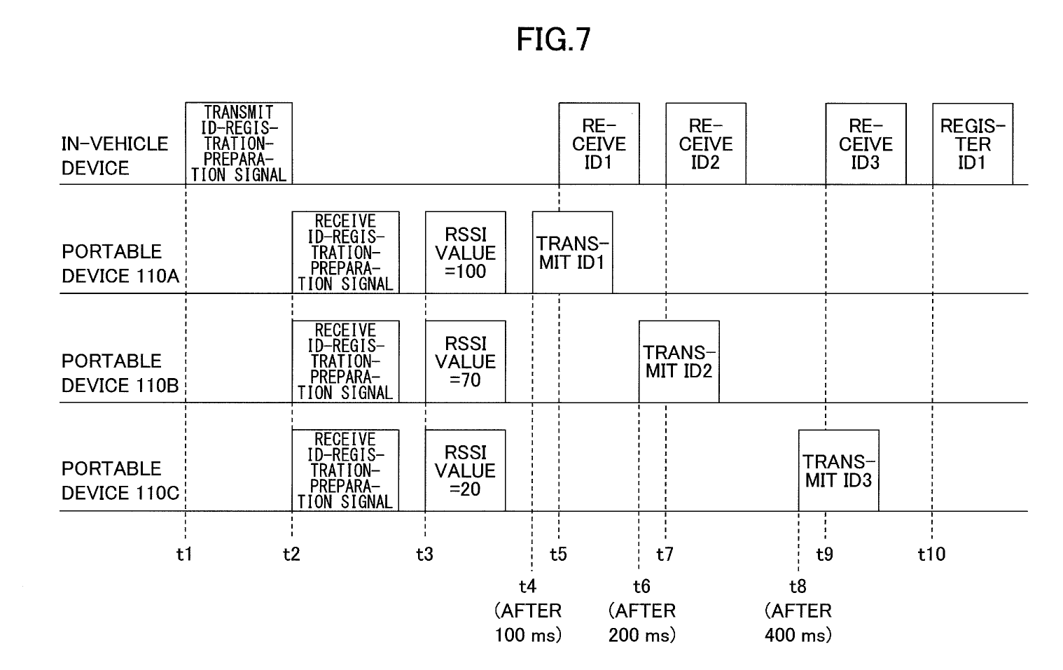

FIG. 7 is a diagram illustrating timing of various operations in the electronic key system 10 according to one embodiment. FIG. 7 illustrates operation timing of each device (the in-vehicle device 100 and the electronic keys 110A, 110B and 110C) in the case where the three electronic keys 110A, 110B and 110C exist in the surroundings of the electronic key system 10 and the remote starting device 120, as illustrated in FIG. 6.

In the example of FIG. 7, for example, upon receipt of an ID-registration-request signal from any of electronic keys 110, the operation of the in-vehicle device 100 is switched to the “registration mode”. The in-vehicle device 100 then transmits an ID-registration-preparation signal to surroundings of the in-vehicle device 100 via the remote starting device 120 (timing t1 in FIG. 7). Accordingly, each of the three electronic keys 110A, 110B and 110C receives the ID-registration-preparation signal (timing t2 in FIG. 7). Further, each of the three electronic keys 110A, 110B and 110C measures a RSSI value in communication performed when the ID-registration-preparation signal is received (timing t3 in FIG. 7).

In the example of FIG. 7, the RSSI value measured by the electronic key 110A indicates “100”. The RSSI value measured by the electronic key 110B indicates “70”. The RSSI value measured by the electronic key 110C indicates “20”. In other words, the RSSI value with respect to the electronic key 110A is largest, and the RSSI value with respect to the electronic key 110C is smallest. This is based on a case where the electronic key 110A is positioned closest to the in-vehicle device 100 and the remote starting device 120, and further, the electronic key 110C is positioned farthest from the in-vehicle device 100 and the remote starting device 120, as illustrated in FIG. 6.

In this case, first, based on the determination table illustrated in FIG. 3, the electronic key 110A transmits, to the in-vehicle device 100, ID-registration information (authentication ID=ID1) at the timing of “after 100 ms” corresponding to the RSSI value “100”, through communication (922 MHz) with the remote starting device 120 (timing t4 in FIG. 7). Accordingly, the in-vehicle device 100 receives the ID-registration information (authentication ID=ID1) transmitted by the electronic key 110A (timing t5 in FIG. 7).

Subsequently, based on the determination table illustrated in FIG. 3, the electronic key 110B transmits, to the in-vehicle device 100, ID-registration information (authentication ID=ID2) at the timing of “after 200 milliseconds” corresponding to the RSSI value “70”, through communication (922 MHz) with the remote starting device 120 (timing t6 in FIG. 7). Accordingly, the in-vehicle device 100 receives the ID-registration information (authentication ID=ID2) transmitted by the electronic key 110B (timing t7 in FIG. 7).

Subsequently, based on the determination table illustrated in FIG. 3, the electronic key 110C transmits, to the in-vehicle device 100, ID-registration infoLmation (authentication ID=ID3) at the timing of “after 400 ms” corresponding to the RSSI value “20”, through communication (922 MHz) with the remote starting device 120 (timing t8 in FIG. 7). Accordingly, the in-vehicle device 100 receives the ID-registration information (authentication ID=ID3) transmitted by the electronic key 110C (timing t9 in FIG. 7).

In such a manner, in the example of FIG. 7, ID-registration information transmitted at an earliest timing is the ID-registration information (authentication ID=ID1) transmitted by the electronic key 110A. In this case, the in-vehicle device 100 selects, as a target ID-registration information, the ID-registration information (authentication ID=ID1) transmitted by the electronic key 110A. Further, the in-vehicle device 100 registers this ID-registration information (authentication ID=ID1) in the storage unit 200 (timing t10 in FIG. 7).

As a result, the ID-registration information (authentication ID=ID1) with respect to an authorized electronic key 110A is registered with the in-vehicle device 100. Note that each of the electronic keys 110A, 110B and 110C transmits ID-registration information to the in-vehicle device 100 through communication with the remote starting device 120, which is performed on a usage frequency of 922 MHz. However, as illustrated in FIG. 7, with respect to each of the electronic keys 110A, 110B and 110C, the transmission timing of corresponding ID-registration information is different from each other. For this reason, transmission waves with use for different ID-registration information do not interfere. Thereby, the in-vehicle device 100 is able to successfully register the ID-registration information (authentication ID=ID1) of the authorized electronic key 110A.

As described above, in the present embodiment, a plurality of electronic keys 110 (portable devices) can each transmit ID-registration information at a different timing corresponding to a RSSI value (signal intensity value), which varies depending on a distance from the in-vehicle device 100 (authentication device). Further, in the present embodiment, an electronic key 110 that is positioned closest to the in-vehicle device 100 can transmit an authentication ID at an earliest timing.

In such a manner, according to the present embodiment, an authorized electronic key 110 that exists inside the vehicle 20 (e.g., a location closest to the in-vehicle device 100) is registered. Thereby, an authentication ID of such an electronic key 110 is able to be surely registered, while authentication ID(s) of other electronic key(s) 110 that exist outside the in-vehicle device 100 are not able to be registered. Also, in the present embodiment, because transmission waves in use for respective authentication IDs are transmitted at a different timing, interference of these transmission waves for the authentication IDs can be prevented. Thereby, in the present embodiment, in a case of registering an authentication ID of a given electronic key 110 with the in-vehicle device 100, the authentication ID of the given authorized electronic key 110 can be successfully registered, even when authentication IDs are transmitted by respective electronic keys 110 that exist in the surroundings of the in-vehicle device 100.

Further, in the present embodiment, communication between the electronic key 110 and the remote starting device 120 is performed on a specific frequency that is usable in bidirectional communication performed on a same frequency. In such a manner, according to the present embodiment, for communication between the electronic key 110 and the remote starting device 120, the radio propagation characteristics can be common to bidirectional communication. Thereby, the relationship between a RSSI value relating to the radio wave propagation characteristics and the transmission timing relating to the radio wave propagation characteristics during transmission can be increased.

Further, in the present embodiment, a specific frequency for use in communication between the electronic key 110 and the remote starting device 120 is 922 MHz. Thereby, communication can be achieved at a longer distance than communication performed by an authentication function of the in-vehicle device 100. Note that, in a case where communication distances are longer, the likelihood of receiving a transmission wave from an electronic key 110 that is not subject to registration may be increased. However, in the present embodiment, even in such a case, interference of multiple transmission waves does not occur, and only an authentication ID of an authorized electronic key 110 can be registered with the in-vehicle device 100.

Note that a configuration of the present embodiment is useful in a case where a user newly registers an authentication ID of an electronic key 110 with the in-vehicle device 100, by way of example. In this case, registration of authentication ID(s) of other electronic key(s) 110, which are used by other person(s) existing in the surroundings of the user, can be prevented. Alternatively, a failure to register a target authentication ID can be avoided on account of being affected by transmission waves from other electronic key(s) 110 of other person(s).

Further, a configuration of the present embodiment is useful in a case where, in a work line in a factory, an operator initially registers an authentication ID of an electronic key 110 with the in-vehicle 100, by way of example. In this case, registration of authentication ID(s) of other electronic key(s) 110, which exist in other work lines, can be prevented. Alternatively, a failure to register a target authentication ID can be avoided on account of being affected by transmission waves from other electronic key(s) 110 in another work line.

As described above, the embodiments of the present disclosure have been described in detail, but are not limited to these examples. It will be appreciated by those skilled in the art that various modifications or changes to the foregoing embodiments are made within the scope of the present invention or the equivalent thereof.

For example, in the above embodiments, ID-registration information transmitted at an earliest timing is registered. However, ID-registration information transmitted at an earliest timing within a predetermined period may be registered. In such a manner, in a case where there is no ID-registration information transmitted within the predetermined period, no ID-registration information may be registered. Also, for example, when a location other than a location closest to the in-vehicle device 100 is set as a predetermined registration location, ID-registration information transmitted at predetermined timing other than an earliest timing may be registered in accordance with such a predetermined registration location. Further, ID-registration information may be transmitted at a timing that becomes later as a RSSI value increases, and then ID-registration information transmitted at a latest timing may be registered.

In the above embodiments, the remote starting device 120 is provided outside the in-vehicle device 100, but may be provided inside the in-vehicle vehicle device 100.

In the above embodiment, an authentication ID of an electronic key 110 is registered through communication (922 MHz) with the remote starting device 120. However, the authentication ID of the electronic key 110 may be registered with the in-vehicle device 100 though direct communication between the electronic key 110 and the in-vehicle device 100, without using the remote starting device 120.

An authentication ID of an electronic key 110 may be registered with the in-vehicle device 100 through communication with an intermediate device other than the remote starting device 120. In this case, the intermediate device may be installed outside the in-vehicle device 100, or be installed inside the in-vehicle device 100.

An authentication ID of an electronic key 110 may be registered with the in-vehicle vehicle 100 through communication over a frequency band other than 922 MHz. In this case, a usable frequency is not particularly limited to a specific frequency, but may preferably be a frequency (e.g., a higher frequency than 315 MHz used by an authentication function) that enables a longer communication distance than a frequency used by an authentication function.

In the above embodiment, when a RSSI value measured by an electronic key 110 is less than or equal to a predetermined value (e.g., “79” or less as illustrated in the determination table of FIG. 3), or when a transmission timing (transmission delay time) determined based on a RSSI value indicates a predetermined period (e.g., “200 ms” or more as illustrated in the determination table in FIG. 3), ID-registration information may not be transmitted by the electronic key 110.

Also, in the above embodiments, as an example, an electronic key system for a vehicle has been described. However, in the case of an authentication system in which authentication can be achieved using an authentication ID of a portable device, the authentication system can be applied to other authentication systems. For example, the authentication system is applicable for a household electronic key system.

What is claimed is:

1. An authentication system comprising:
at least one portable device including:
a measurement unit configured to measure a signal intensity value in communicating with an authentication device, prior to registering of an authentication ID of the portable device by the authentication device; and
an ID transmitting unit configured to transmit, to the authentication device, the authentication ID at a transmission timing depending on the signal intensity value measured by the measurement unit; and
the authentication device including:
a receiving unit configured to receive the authentication ID transmitted by the portable device;
a determination unit configured to select, as a target authentication ID, the authentication ID transmitted at a predetermined timing by the portable device, among at least one authentication ID received by the receiving unit; and
a registration unit configured to register the target authentication ID selected by the determination unit.

2. The authentication system according to claim 1, wherein the ID transmitting unit is configured to transmit the authentication ID to the authentication device such that the transmission timing becomes earlier in accordance with the signal intensity value being greater, and
wherein the determination unit is configured to select, as the target authentication ID, the authentication ID transmitted at an earliest transmission timing, among the at least one authentication ID received by the receiving unit.

3. The authentication system according to claim 2, wherein the determination unit is configured to select, as the target authentication ID, the authentication ID transmitted at the earliest transmission timing within a predetermined period, among the at least one authentication ID received by the receiving unit.

4. The authentication system according to claim 1, wherein the ID transmitting unit is configured to transmit the authentication ID to the authentication device on a specific frequency that is usable in bidirectional communication performed on a same frequency.

5. The authentication system according to claim 4, wherein the specific frequency is different from a frequency for use in authentication for the portable device.

6. The authentication system according to claim 1, further comprising an intermediate device provided in or outside the authentication device,
wherein the measurement unit is configured to measure the signal intensity value in communicating with the authentication device through the intermediate device, and
wherein the ID transmitting unit is configured to transmit the authentication ID to the authentication device through the intermediate device.

7. The authentication system according to claim 6, wherein the intermediate device is a remote starting device configured to remotely operate an engine of a vehicle through the portable device.

8. A portable device comprising:
a measurement unit configured to measure a signal intensity value in communicating with an authentication device, prior to registering of an authentication ID of the portable device by the authentication device; and
an ID transmitting unit configured to transmit, to the authentication device, the authentication ID at a transmission timing depending on the signal intensity value measured by the measurement unit.

9. A registration method comprising:
measuring, by at least one portable device, a signal intensity value in communicating with an authentication device, prior to registering of an authentication ID of the portable device by the authentication device;
transmitting, by the portable device, to the authentication device, the authentication ID at a transmission timing depending on the signal intensity value measured in the measuring;
receiving, by the authentication device, the authentication ID transmitted by the portable device;
selecting, by the authentication device, as a target authentication ID, the authentication ID transmitted at a predetermined timing by the portable device, among at least one authentication ID received in the receiving; and
registering the target authentication ID selected in the selecting.

10. An authentication device comprising:
a receiving unit configured to receive an authentication ID transmitted by a portable device;
a determination unit configured to select, as a target authentication ID, the authentication ID transmitted at a predetermined timing by the portable device, among at least one authentication ID received by the receiving unit; and
a registration unit configured to register the target authentication ID selected by the determination unit.
